(19) United States
(12) Patent Application Publication
(10) Pub. No.: US 2026/0122194 A1
(43) Pub. Date: Apr. 30, 2026

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: Kazuki KADO, Kanagawa (JP)

(21) Appl. No.: 19/371,495

(22) Filed: Oct. 28, 2025

(30) Foreign Application Priority Data
Oct. 30, 2024 (JP) 2024-190906

(51) Int. Cl. H04N 1/387; H04N 1/00; H04N 1/393

(52) U.S. Cl. CPC H04N 1/3875; H04N 1/0044; H04N 1/393; H04N 2201/0094

(57) ABSTRACT

An image forming apparatus includes at least one memory storing instructions, and at least one processor that, upon execution of the stored instructions, causes the at least one processor to operate as: a first acquisition unit configured to acquire an output paper size, a second acquisition unit configured to acquire a paper size after cutting; and, a first control unit configured to perform control to allocate a document having the paper size after cutting to output paper having the output paper size to perform printing.

### BACKGROUND

### Field of the Technology

The present disclosure relates to an image forming apparatus, a method for controlling the image forming apparatus, and a storage medium.

### Description of the Related Art

Conventionally, there have been known functions that allocate a plurality of documents to a single sheet of printing paper, allocate a plurality of copies of an identical document to a single sheet of printing paper, and change the sizes of documents to be output. These functions change the original size of a document to a different paper size to print the document based on the intended use after printing, and can be used during copying or printing.

Further, a technique is known in which, on the assumption that a user cuts the sheets after printing, two pages of documents are combined and printed on the same side of a single sheet, so that N copies are sorted in the page order from page one to page D, with one set of cut sheets stacked under the other set of cut sheets (Japanese Patent Application Laid-Open No. 2002-281278).

However, Japanese Patent Application Laid-Open No. 2002-281278 describes no method for specifying a desired paper size created by cutting sheets with respect to a size of printing paper to be output for a user to cut the sheets into the desired paper size after printing. For example, a technique of allocating a plurality of documents involves setting the number of divisions made of a size of an output sheet. For that reason, if the user wishes to cut sheets of paper to the A5 size, it is a necessary for the user to have prior knowledge about paper sizes, such as how many divisions made of an A3 sheet are required.

Consequently, it is difficult for users that cut any feedable sheets of paper into desired paper sizes to be used after printing to understand print settings.

### SUMMARY

The present disclosure is directed to enabling printing, with simple settings, by allocating documents in a paper size after cutting to an output sheet with an output paper size.

According to embodiments of the present disclosure, an image forming apparatus includes at least one memory storing instructions, and at least one processor that, upon execution of the stored instructions, causes the at least one processor to operate as: a first acquisition unit configured to acquire an output paper size, a second acquisition unit configured to acquire a paper size after cutting; and, a first control unit configured to perform control to allocate a document having the paper size after cutting to output paper having the output paper size to perform printing.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an image forming system.

FIG. 2 is a diagram illustrating a configuration of an image forming apparatus.

FIG. 3 is an external view of an input device and an output device in the image forming apparatus.

FIG. 4 is a detailed view of an operation unit in the image forming apparatus.

FIG. 5 is a diagram illustrating a display example of the operation unit.

FIG. 6 is a diagram illustrating a function setting screen.

FIG. 7 is a diagram illustrating an example of a setting screen on which a user sets an output paper size and a paper size after cutting.

FIG. 8 is a diagram illustrating an example of a setting screen on which the user sets an output paper size and a paper size after cutting.

FIG. 9 is a diagram illustrating an example of a setting screen regarding a paper size after cutting.

FIG. 10 is a diagram illustrating an example of a setting screen regarding a document paper size.

FIG. 11 is a diagram illustrating an example of a paper feed cassette selection screen.

FIG. 12 is a flowchart illustrating processing of a copy function suitable for cutting after outputting.

FIG. 13 is a table showing an example regarding an output sheet of paper and documents allocated to the output sheet of paper.

FIG. 14 is a diagram illustrating an example regarding an output sheet of paper and documents allocated to the output sheet of paper.

FIG. 15 is a flowchart illustrating processing of a copy function that allows the number of copies after cutting to be set.

FIG. 16 is a table showing an example regarding output sheets of paper and documents allocated to the output sheets of paper.

FIG. 17 is a diagram illustrating an example regarding output sheets of paper and documents allocated to the output sheets of paper.

FIG. 18 is a diagram illustrating an example of a screen to issue a notification about the setting of the number of copies after cutting.

FIG. 19 is a diagram illustrating an example of a screen to issue a notification about the setting of the number of copies after cutting.

FIG. 20 is a diagram illustrating an example of a screen displaying a blank slot removal button.

FIG. 21 is a flowchart illustrating processing of a copy function suitable for cutting after outputting without a blank slot.

FIG. 22 is a table showing an example regarding output sheets of paper and documents allocated to the output sheets of paper with blank slots.

FIG. 23 is a diagram illustrating an example regarding output sheets of paper and documents allocated to the output sheets of paper with blank slots.

FIG. 24 is a table showing an example regarding output sheets of paper and documents allocated to the output sheets of paper without a blank slot.

FIG. 25 is a view illustrating an example regarding output sheets of paper and documents allocated to the output paper without a blank slot.

FIG. 26 illustrates a table and a view for describing a cutting process of a copy function suitable for cutting after outputting without a blank slot.

FIG. 27 is a diagram illustrating a print setting screen.

FIG. 28 is a diagram illustrating a pull-down menu on the print setting screen.

### DESCRIPTION OF THE EMBODIMENTS

An embodiment will now be described with reference to the drawings. The claimed disclosure is not limited to configurations described in the embodiment. Part or all of the configurations can be substituted for equivalents as long as the same effect as the intended effect can be produced.

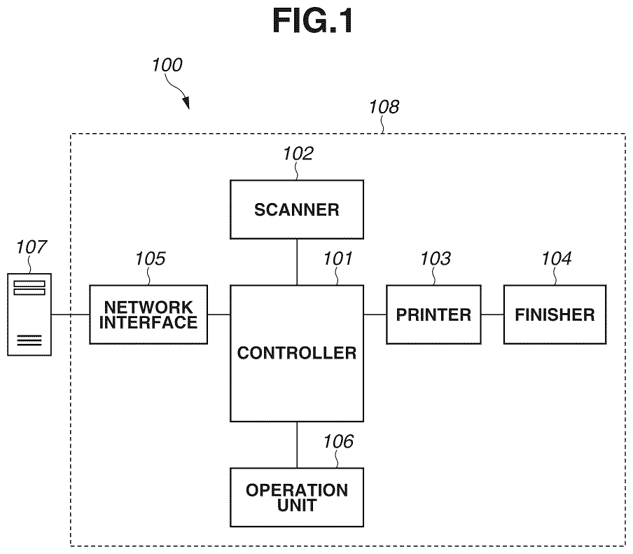

FIG. 1 is a diagram illustrating a configuration example of an image forming system 100 according to the present embodiment. The image forming system 100 includes a personal computer 107 and an image forming apparatus 108. As an example of the image forming apparatus 108, a configuration will be described of a multi-function peripheral (MFP).

The image forming apparatus 108 includes a controller 101, a scanner 102, a printer 103, a finisher 104, a network interface 105, and an operation unit 106.

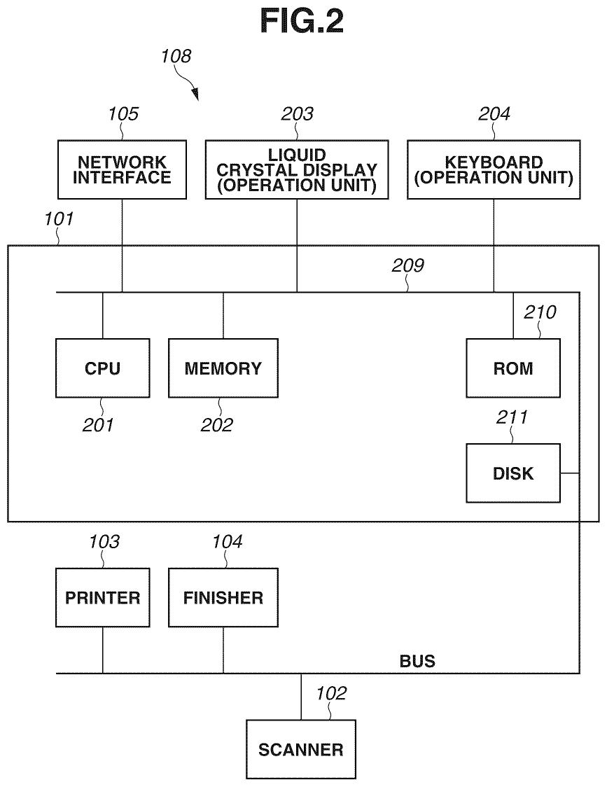

In FIG. 1, the controller 101 controls an MFP and has a hardware configuration illustrated in FIG. 2.

The scanner 102 is a scanner engine controlled by the controller 101.

The printer 103 is a laser beam printer engine controlled by the controller 101.

The printer 103 is connected to the finisher 104 to allow stapling (stapler) and saddle-stitch processing collectively on a plurality of recording media (for example, sheets of paper) output from the printer 103.

The finisher 104 is also controlled by the controller 101.

The network interface 105 provides interactive communication between the controller 101 and the personal computer 107 via the network interface 105, and can be connected to the personal computer 107 via a network.

The operation unit 106 is a user interface including a liquid crystal display (LCD) and a keyboard. The operation unit 106 displays information from the controller 101 and notifies the controller 101 of instructions from the user.

Additionally, all the functions can also be used from interfaces on a network or the like.

FIG. 2 is a diagram illustrating an example of a hardware configuration of the image forming apparatus 108 illustrated in FIG. 1. The image forming apparatus 108 includes the controller 101, the scanner 102, the printer 103, the finisher 104, the network interface 105, a liquid crystal display 203, and a keyboard 204. The liquid crystal display 203 and the keyboard 204 correspond to the operation unit 106 in FIG. 1.

The controller 101 includes a central processing unit (CPU) 201, a memory 202, a bus 209, a read-only memory (ROM) 210, and a disk 211.

Inside the controller 101, the CPU 201 is connected to the liquid crystal display 203 and the keyboard 204 that constitute the operation unit 106, the memory 202, the ROM 210, and the disk 211 via the bus 209.

Various kinds of programs and data stored in the disk 211 (storage medium), such as a hard disk or a flexible disk, are successively loaded into the memory 202 as necessary to be executed by the CPU 201. The disk 211 may be detachably mounted in the image forming apparatus 108 or be built into the image forming apparatus 108.

Further, a configuration can be employed in which a program is downloaded from another image forming apparatus via the network to be stored in the disk 211.

The memory 202 is a non-volatile memory, such as a dynamic random access memory (DRAM) or a volatile memory, such as a static random access memory (SRAM). The memory 202 can have functions of both a non-volatile memory and a volatile memory. A configuration can be employed in which the memory 202 has the function of a volatile memory and the disk 211 has the function of a non-volatile memory.

The memory 202 can be a removable memory medium.

The liquid crystal display 203 and the keyboard 204 are included in the operation unit 106 illustrated in FIG. 1.

The CPU 201 performs display by writing data in the liquid crystal display 203, and inputs instructions from the user by reading data from the keyboard 204 or the liquid crystal display 203 serving as the touch panel.

The input information is transferred to and accumulated in any of the memory 202, the disk 211, and the CPU 201, and used in various kinds of processing.

The network interface 105 is connected to the bus 209. The CPU 201 reads from or writes to the network interface 105 to perform communication using the network interface 105.

Further, the printer 103, the finisher 104, and the scanner 102 are connected to the bus 209.

The CPU 201 reads data from and writes data to the printer 103, the finisher 104, and the scanner 102 to perform an engine operation, such as printing or scanning, and acquire various kinds of statuses.

Image data from the scanner 102 or from the network interface 105 can be stored in the disk 211 or the memory 202 in the controller 101.

Image data can be imported to the controller 101 through the removable memory 202 where the image data has preliminarily been accumulated with the memory 202 mounted on the controller 101.

The image data accumulated in the disk 211 can be moved or copied to the memory 202, and the image data in the memory 202 can be subjected to various kinds of layout processing depending on the instruction issued by the operation unit 106.

Alternatively, the controller 101 in the image forming apparatus 108 may control the printer 103, the finisher 104, and the scanner 102, all of which exist as independent peripheral devices on a network, instead of the configuration where the printer 103, the finisher 104, and the scanner 102 are included in the image forming apparatus 108.

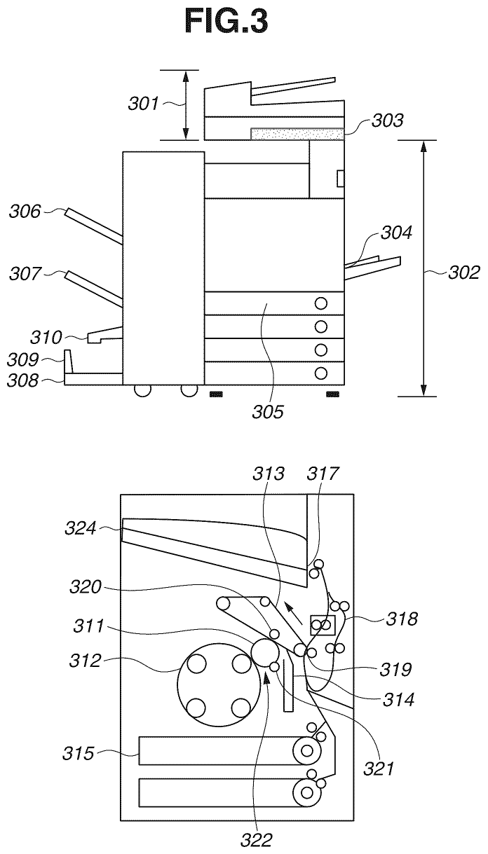

FIG. 3 is an external view of the image forming apparatus 108. While a scanner unit 301 as an image input device is illuminating an image on a sheet of paper as a document the scanner unit 301 scans the sheet with a charge-coupled device (CCD) line sensor to convert the image on the document placed on the scanner unit 301 into electrical image data. Color determination, size detection and the like of the document are performed based on the electrically converted image data.

A printer unit 302 as an image output device converts the image data into an image on a sheet of paper. After printing on sheets, the printer unit 302 performs stapling or folding on the sheets, such as bookbinding, to output the sheets. The start and the end of a printing operation are performed through instructions from the CPU 201.

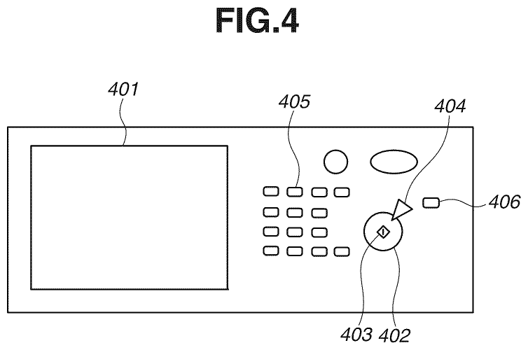

FIG. 4 illustrates a configuration of an operation unit 303. A touch panel sheet is attached to a liquid crystal panel in a liquid crystal display unit 401. The liquid crystal display unit 401 displays a system operation screen and software keys. When a displayed key is pressed, positional information regarding the displayed key is transmitted to the CPU 201.

A start key 402 is used at the time of starting an operation of reading a document image or the like. Light emitting diodes (LEDs) 403 in two colors, green and red, are disposed in a middle portion of the start key 402, and the LEDs 403 indicate whether the start key 402 is ready for use using the colors of the LEDs 403. A stop key 404 functions to stop an operation in execution.

A numeric keypad 405 includes a group of numeric and character buttons used to issue instructions for setting the number of copies and switching between screens of the liquid crystal display unit 401. A user mode key 406 is pressed when the user configures device settings.

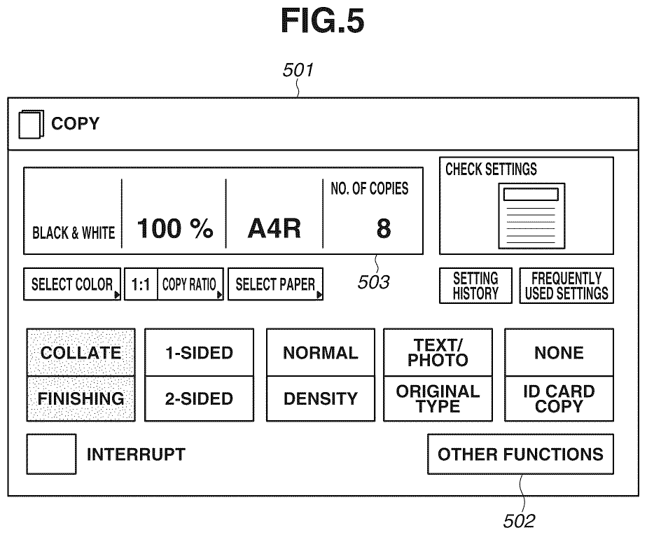

FIG. 5 illustrates an example of display of the liquid crystal display unit 401 A copy basic screen 501 is an example of display of the liquid crystal display unit 401. The user can select a cassette to be used and set a copy ratio on the copy basic screen 501. The number of copies 503 can be set to a number entered via the numeric keypad 405.

Sheets of paper for printing are set on a manual feed tray 304 and in paper feed cassettes 305 illustrated in FIG. 3.

Printed sheets of paper are output on paper discharge trays 306 and 307.

Saddle-stitched sheets of paper are output on a saddle tray 308. The saddle tray 308 includes a stopper 309 configured to prevent saddle-stitched output products from falling off and a tray sensor 310 configured to issue a notification that the saddle tray 308 is full of saddle-stitched output products.

The printer 302 will be described in detail. FIG. 3 illustrates an example of the full-color image forming apparatus 108. A photosensitive drum 311 is subjected to charging processing to have a potential of a specific polarity by primarily charging unit 321., and is exposed at a position indicated by an arrow 322 by an exposure unit, which is not illustrated, which thus forms an electrostatic latent image corresponding to a first color component. Thereafter, the electrostatic latent image is developed using one of four developing devices 312.

An intermediate transfer belt 313 is driven in an arrow direction, and an image having a first color component formed on the photosensitive drum 311 is transferred to the intermediate transfer belt 313 by electric field formed by a primary transfer roller 320 during passing through a contact portion between the photosensitive drum 311 and the intermediate transfer belt 313.

The surface of the photosensitive drum 311 after the completion of transfer of the image to the intermediate transfer belt 313 is cleaned with a cleaning device 314. By repetition of this processing in sequence, images in four colors are superimposed on the intermediate transfer belt 313, forming a color image. In a case where a monochrome image is formed, transfer processing is performed only once.

The image transferred to the intermediate transfer belt 313 is printed on a sheet of paper fed from a cassette 315 at a secondary transfer roller 319. The sheet with the image printed thereon is heated to be fixed by a fixing device 316. After fixing, the sheet passes through a portion 317, is conveyed to a paper discharge port 324, and is discharged to the outside of the image forming apparatus 108. In two-sided printing, the sheet passes through an inversion path 318 and is circulated, and print processing is repeated.

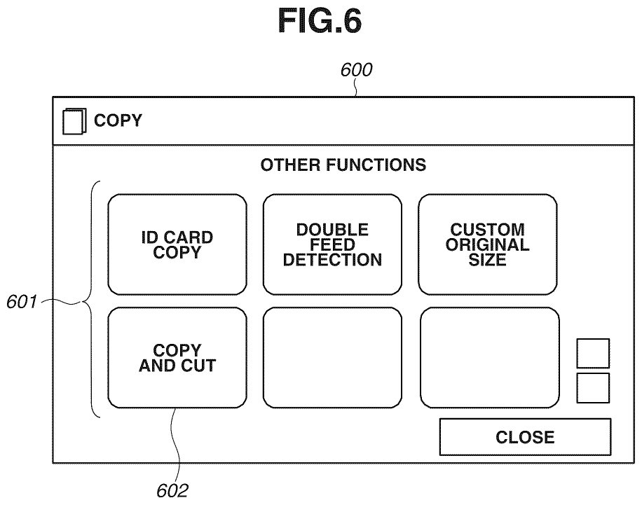

FIG. 6 illustrates a function setting screen to be displayed after a button 502 on the copy basic screen 501 illustrated in FIG. 5 is pressed. A function setting screen 600 includes a function button group 601. By selecting a function desired to be set from among the function button group 601, detailed function settings can be configured. For example, a copy-and-cut button 602 is used to transition to a screen for setting a copy function with a layout optimum for cutting in a post process (a cutting-oriented copy).

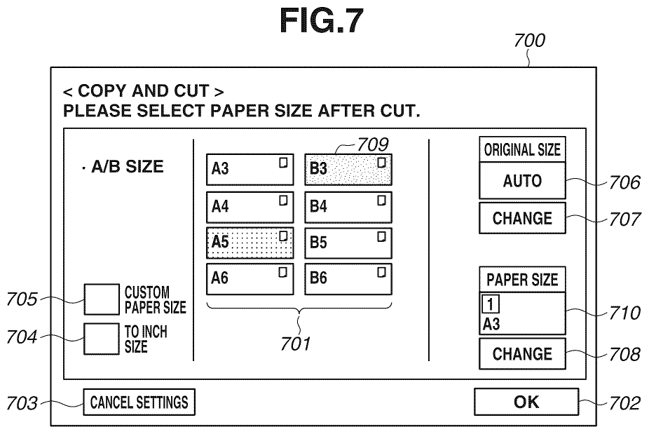

FIG. 7 illustrates an example of a copy-and-cut setting screen 700, which makes it possible for the user to configure settings regarding cut copy with, and to determine the settings by pressing an OK button 702. Pressing a setting cancel button cancels the settings. When the OK button 702 or the setting cancel button 703 is pressed, the screen transitions to the copy basic screen 501. The settings are stored by the CPU 201 in the disk 211 or the memory 202.

Selecting one button from a paper-size-after-cut button group 701 makes it possible to set the paper size after cutting. In the paper-size-after-cut button group 701, standard sizes are displayed. In FIG. 7, A3, A4, A5, A6, B3, B4, B5, and B6 are displayed as an example. When an inch size switching button 704 is pressed, the standard sizes for the paper-size-after-cut button group 701 can be changed from A/B system sizes to inch system sizes.

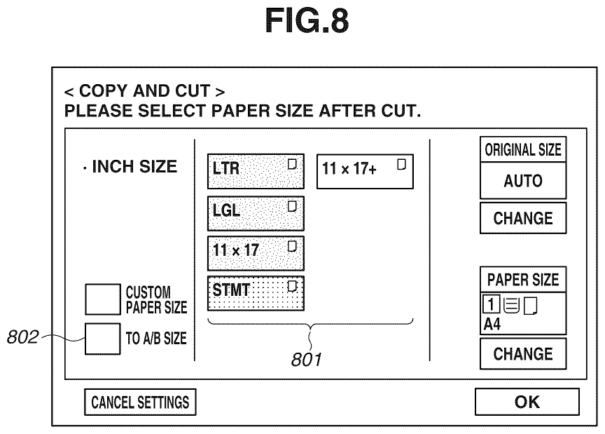

FIG. 8 illustrates a screen displayed when the sizes are changed to the inch system sizes. In FIG. 8, inch system standard sizes are displayed in a paper-size-after-cut button group 801. As an example, LTR, LGL, 11×17, STMT, 11×17+ are displayed. Further, in FIG. 8, instead of the inch size switching button 704, an A/B size switching button 802 is displayed. When the A/B size switching button 802 is pressed, the screen illustrated in FIG. 7 is displayed again.

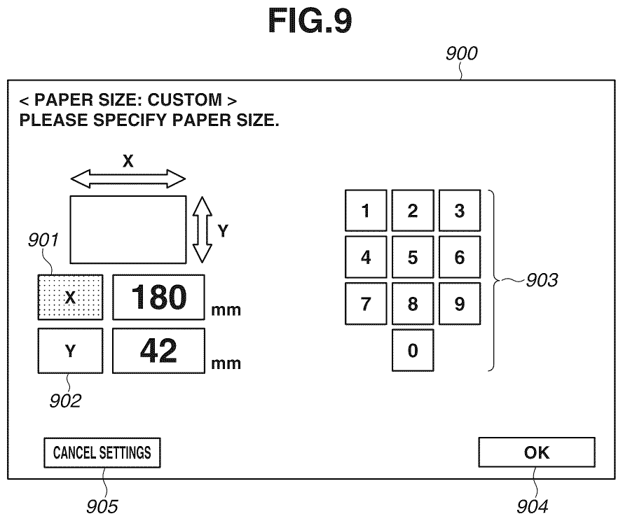

When a custom specification button 705 is pressed, the screen transitions to a custom paper size setting screen 900 illustrated in FIG. 9. The custom paper size setting screen 900 is used to set a custom paper size after cutting other than the standard sizes. The user can select a button or buttons in a numeric keypad group 903 with an X side length selection button 901 pressed to set a length of an X side. Similarly, the user selects a button or buttons in the numeric keypad group 903 with a Y side length selection button 902 pressed to set a length of a Y side. Pressing an OK button 904 makes it possible to determine the settings. Pressing a setting cancel button 905 makes it possible to cancel the settings. When the OK button 904 or the setting cancel button 905 is pressed, the screen transitions to the copy-and-cut setting screen 700 illustrated in FIG. 7.

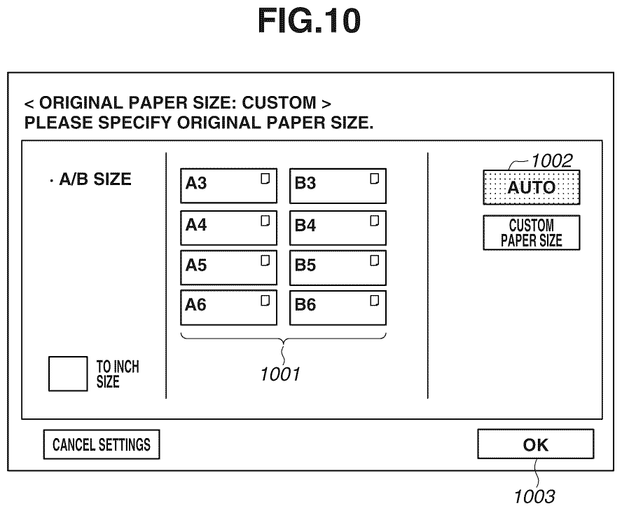

When a document paper size setting button 707 illustrated in FIG. 7 is pressed, the screen transitions to a document paper size setting screen illustrated in FIG. 10. The user selects a size from a document paper size button group 1001 displayed on the document paper size setting screen 1000 to set the document paper size. When an automatic document paper size detection button 1002 is selected, a paper size is set based on a document read by the scanner 102. Pressing the OK button 1003 makes it possible to determine the settings. The settings configured on the document paper size setting screen 1000 are displayed in a document paper size display area 706 illustrated in FIG. 7.

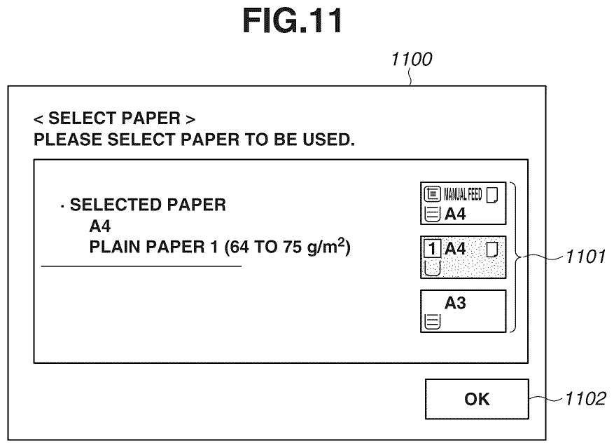

When a paper feed cassette selection button 708 illustrated in FIG. 7 is pressed, the screen transitions to a paper feed cassette selection screen 1100 illustrated in FIG. 11. The user presses a button in a paper feed cassette button group 1101 displayed on the paper feed cassette selection screen 1100 to select the paper feed cassette. Pressing an OK button 1102 makes it possible to determine the setting. The setting configured on the paper feed cassette selection screen 1100 can be displayed in a paper feed cassette display area 710 illustrated in FIG. 7.

A paper size after cutting is selectable from the paper-size-after-cut button group 701 illustrated in FIG. 7. Further, out of the paper-size-after-cut button group 701, sizes larger than the output paper sizes registered in the paper feed cassettes can be hatched to indicate that those sizes are unselectable. For example, when the output paper size registered in the paper feed cassette is A3, it is impossible to allocate B3 size to the paper feed cassette. In this case, a B3 button 709 can be hatched to indicate that the B3 button 709 is unselectable.

After settings are configured on the copy-and-cut setting screen 700, pressing a start key 402 illustrated in FIG. 4 makes it possible to perform cut copying.

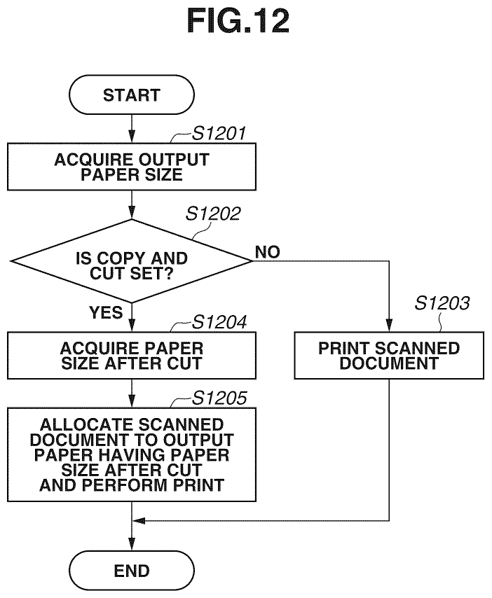

FIG. 12 is a flowchart illustrating specific processing regarding cut copy. In this flowchart, processing starts upon the CPU 201 receiving a copy execution instruction. A method for controlling the image forming apparatus 108 will be described in the following.

In step S1201, the CPU 201 acquires from the disk 211 or the memory 202 an output paper size registered in the paper feed cassette that is set on the paper feed cassette selection screen 1100.

In step S1202, the CPU 201 determines whether a cut copy is set on the copy-and-cut setting screen 700. If the CPU 201 determines that the cut copy is not set (NO in step S1202), the processing proceeds to step S1203. If the CPU 201 determines that the cut copy is set (YES in step S1202), the processing proceeds to step S1204.

In step S1204, the CPU 201 acquires from the disk 211 or the memory 202 a paper size after cutting set on the copy-and-cut setting screen 700.

In step S1205, the CPU 201 performs control to allocate to the maximum each document read by the scanner 102 in the paper size after cutting acquired in step S1204 to an output sheet of paper in the output paper size acquired in step S1201 to perform printing by using the printer unit 302. The flowchart then ends.

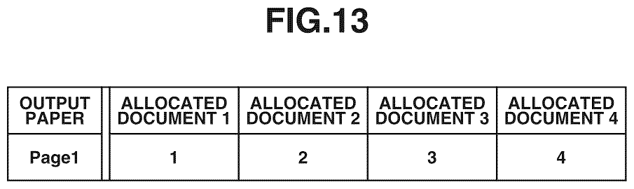

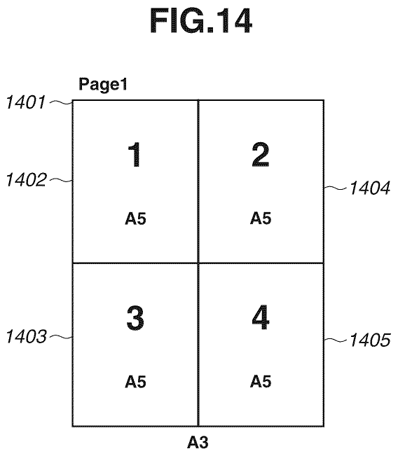

A specific example of an output product will be described with reference to FIGS. 13 and 14. The output product is output with settings of A3 as an output paper size registered in the paper feed cassette, which is set on the paper feed cassette selection screen 1100, A4 as a paper size of each document read by the scanner 102, 4 as the number of sheets, and A5 as a paper size after cutting set on the copy-and-cut setting screen 700.

FIG. 13 is a table showing an example regarding an output sheet of paper and documents allocated to the output sheet of paper when the cut copy illustrated in FIG. 12 is executed. FIG. 13 illustrates the page number of the output sheet of paper and the documents allocated to the output sheet of paper. For example, in FIG. 13, documents 1 to 4 are allocated to the first output sheet of paper (also, referred to as the first page) to be output. Four sheets having the A5 paper size after cutting are allocated to an output sheet of paper having the A3 paper size, and thus, the printer unit 302 reduces the first to the fourth pages having the A4 paper size of the read documents to the A5 paper size after cutting, and then performs printing on the first page of the output sheets of paper.

FIG. 14 illustrates an example of an output sheet of paper and documents allocated to the output sheet of paper in executing the cut copy illustrated in FIG. 12. Documents 1402 to 1405 are allocated in A5 size to an output sheet of paper 1401 having A3 paper size for printing.

After settings are configured on the copy-and-cut setting screen 700, the number of copies after cutting can be set to perform cut copying when pressing the start key 402.

In step S1203 in FIG. 12, the CPU 201 controls the printer unit 302 to print each document read by the scanner 102 on an output sheet of paper having the output paper size without allocating the documents to the paper size after cutting. The flowchart then ends.

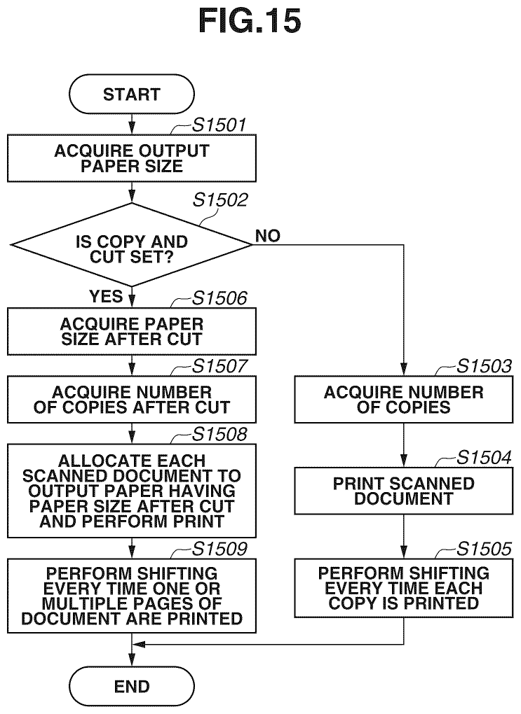

FIG. 15 is a flowchart illustrating specific processing regarding the cut copy in which the number of copies after cutting can be set. In this flowchart, processing starts upon the CPU 201 receiving a copy execution instruction.

In step S1501, similarly to step S1201 in FIG. 12, the CPU 201 acquires from the disk 211 or the memory 202 an output paper size registered in the paper feed cassette, which is set on the paper feed cassette selection screen 1100.

In step S1502, similarly to step S1202 in FIG. 12, the CPU 201 determines whether a cut copy is set on the copy-and-cut setting screen 700 in FIG. 7. If the CPU 201 determines that the cut copy is not set (NO in step S1502), the processing proceeds to step S1503.

If the CPU 201 determines that the cut copy is set (YES in step S1502), the processing proceeds to step S1506.

In step S1506, the CPU 201 acquires from the disk 211 or the memory 202 the output paper size after cutting set on the copy-and-cut setting screen 700 illustrated in FIG. 7.

In step S1507, the CPU 201 acquires from the disk 211 or the memory 202 a value set to the number of copies 503 illustrated in FIG. 5 as the number of copies after cutting.

In step S1508, the CPU 201 performs control the printer unit 302 to print a document read by the scanner 102 on output sheets of the output paper size acquired in step S1501 according to the number of copies after cutting, by allocating to the maximum the paper size after cutting to the output paper size acquired in step S1506. At this time, the same page of the document is allocated to the output sheet of paper.

In step S1509, the CPU 201 controls the finisher 104 to shift the output positions of printed output sheets of paper each time a document consisting of one page or all documents each consisting of multiple pages is or are printed. The flowchart then ends.

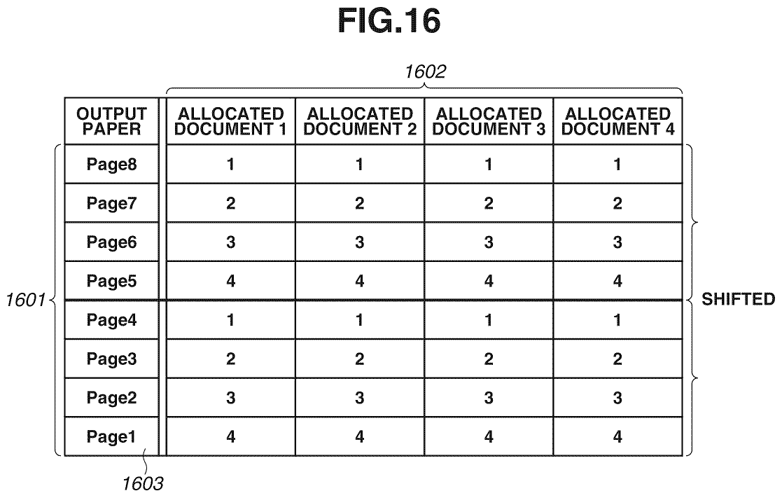

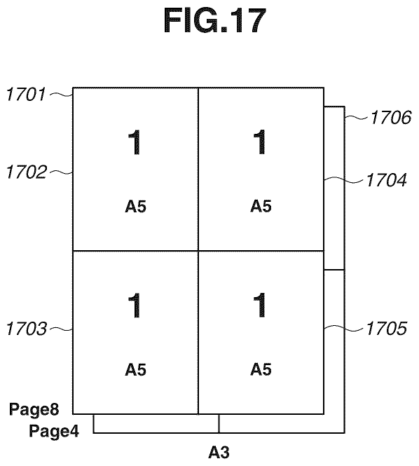

A specific example of an output product will be described with reference to FIGS. 16 and 17. The output product is output with settings of A3 as an output paper size registered in the paper feed cassette, which is set on the paper feed cassette selection screen 1100 illustrated in FIG. 11, A4 as a paper size of the document read by the scanner 102, 4 as the number of sheets, A5 as a paper size after cutting set on the copy-and-cut setting screen 700, and 8 as the number of copies 503.

FIG. 16 is a table showing an example regarding output sheets of paper and documents allocated to the output sheets of paper in executing the cut copy that allows the number of copies to be set after cutting illustrated in FIG. 15. Each row 1601 shows page numbers of the output sheets of paper, and each column 1602 shows a page of a document allocated to the corresponding output sheet of paper. For example, a first row 1603 in the output sheets of paper indicates that the fourth document page is allocated to the first page of the output sheets of paper in each of the four cells. The output sheets of paper constitute a plurality of pages (eight pages) and the document also constitutes a plurality of pages (four pages).

Four sheets having the A5 paper size after cutting can be allocated to an output sheet of paper having the “A3” paper size. Thus, the printer unit 302 reduces the fourth page of the document to the A5 paper size after cutting, and allocates the four fourth pages to the first page of the output sheets of paper to perform printing. Thereafter, the printer unit 302 allocates the four third pages of the read document to the second page of the output sheets of paper, and sequentially performs printing up to the first page of the document. After printing the first page of the document, the printer unit 302 performs shifting using processing in step S1509, and then allocates again the four fourth pages of the document to the fifth page of the output sheets of paper to perform printing. Thereafter, the printer unit 302 allocates again the four third pages of the read document to the sixth page of the output sheets of paper, and sequentially performs printing up to the first page of the document.

FIG. 17 illustrates an example regarding output sheets of paper and a page of the document allocated to the output sheets of paper in executing the cut copy illustrated in FIG. 15, which allows the number of copies after cutting can be set. The first page of the document is allocated to portions 1702 to 1705 on an eighth page 1701 of the output sheets of paper for printing. Further, shifting is performed on a fourth page 1706 of the output sheets of paper.

When the cut copy that allows the number of copies after cutting can be set illustrated in FIG. 15 is executed, cutting each of the shifted output sheets of paper makes it possible to create a printed product desired by the user without sorting or grouping of the sheets of paper. For example, in the specific example illustrated in FIGS. 16 and 17, cutting the first to fourth pages of the output sheet of paper having A3 size makes it possible to create four bundles of paper having A5 size in which the first to fourth pages of the document are arranged. Subsequently, cutting the fifth to eighth pages of the shifted output paper makes it possible to further create four bundles of paper having A5 size in which the first to fourth pages of the document are arranged. Thus, the configuration with the simple settings provides a total of eight bundles of paper having A5 size in which the first to fourth pages of the document are arranged as intended by the user.

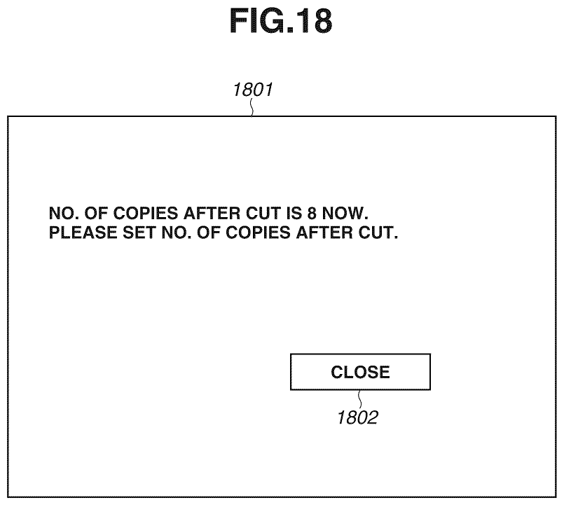

In the flowchart in FIG. 15, the setting set of the number of copies after cutting may be displayed to the user. Specifically, upon the OK button 702 being pressed on the copy-and-cut setting screen 700 illustrated in FIG. 7 to determine the settings, a value set to the number of copies 503 in FIG. 5 is notified to the user as the number of copies after cutting. FIG. 18 illustrates a pop-up screen as a display example of the notification. If the value set to the number of copies 503 in FIG. 5 is eight, a phrase, such as “NO. OF COPIES AFTER CUT IS 8 NOW. PLEASE SET NO. OF COPIES AFTER CUT.” is displayed in a pop-up 1801. The pop-up 1801 can be closed by pressing a close button 1802.

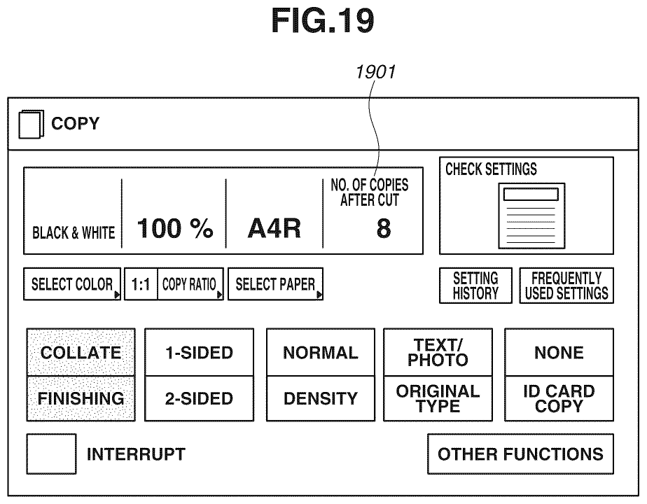

Further, the fact that the number of copies 503 in FIG. 5 is the number of copies after cutting can be displayed on the copy basic screen 501. FIG. 19 illustrates a display example. Displaying a phrase, such as “NO. OF COPIES AFTER CUT”, in a number of copies display area 1901 makes it possible to clearly indicate to the user that the value set to the number of copies 503 in FIG. 5 is the number of copies after cutting. In this manner, notifying the user of the value set to the number of copies 503 as the number of copies after cutting makes it possible to prevent unintended numbers of copies from being output.

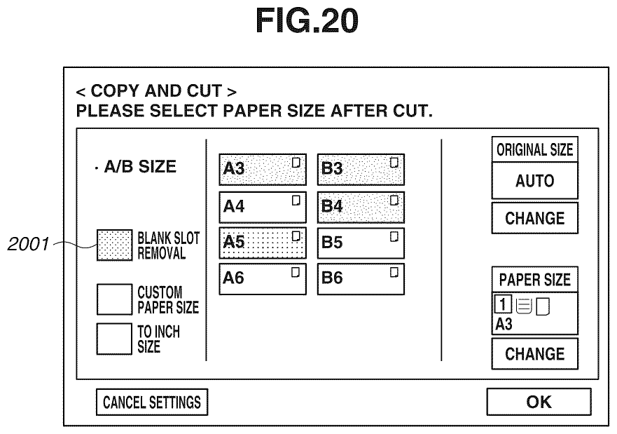

In the flowchart illustrating the specific processing regarding the cut copy in FIG. 15 that allows the number of copies after cutting to be set, a blank slot or blank slots of the output sheets of paper can be removed. On the copy-and-cut setting screen 700 in FIG. 7, selecting a blank slot removal button 2001 as illustrated in FIG. 20 makes it possible for the user to remove a blank slot or blank slots of the output sheets of paper in the cut copy that allows the number of copies to be set.

In step S1503 in FIG. 15, the CPU 201 acquires from the disk 211 or the memory 202 the value set to the number of copies 503 illustrated in FIG. 5.

In step S1504, the CPU 201 controls the printer unit 302 to print the document read by the scanner 102 according to the number of copies set in step S1503 on the output sheets of paper having the output paper size without allocating the document in the output paper size after cutting.

In step S1505, the CPU 201 controls the finisher 104 to shift the output position of printed output sheets of paper each time the number of copies 503 in FIG. 5 is printed. The flowchart then ends.

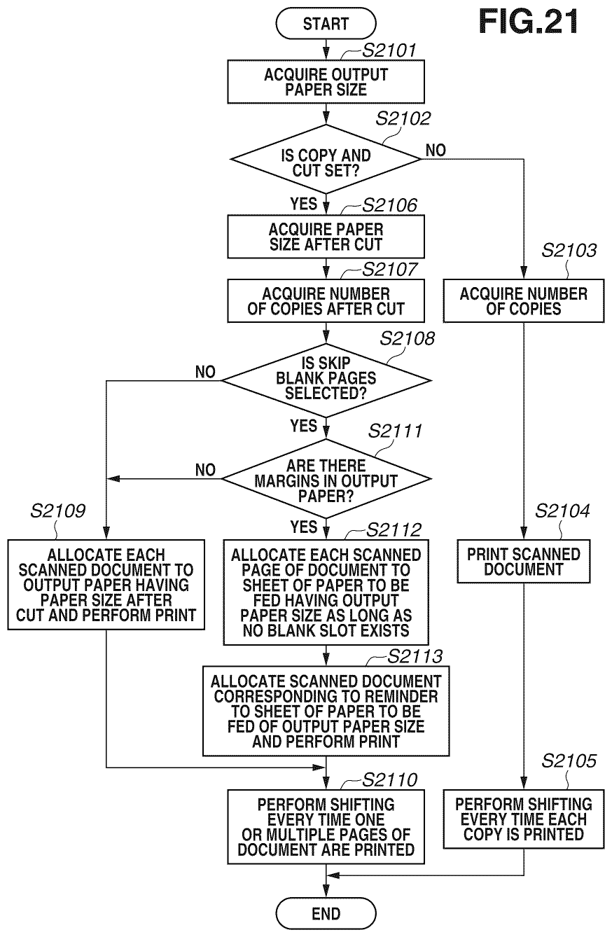

FIG. 21 is a flowchart illustrating specific processing regarding cut copy that allows the number of copies after cutting can be set with any blank slot removed. In this flowchart, processing starts upon the CPU 201 receiving a copy execution instruction.

Steps S2101 to S2107 are similar to steps S1501 to S1507 in the flowchart in FIG. 15 that illustrates the specific processing regarding the cut copy that allows the number of copies after setting to be set.

In step S2108, the CPU 201 determines whether the blank slot removal button 2001 illustrated in FIG. 20 is selected. If the blank slot removal button 2001 illustrated in FIG. 20 is selected (YES in step S2108), the CPU 201 determines that any blank slot is to be removed, and the processing proceeds to step S2111. If the blank slot removal button 2001 is not selected (NO in step S2108), the CPU 201 executes processing in steps S2109 and S2110, and the flowchart ends.

Processing in steps S2109 and S2110 is the same as that in steps S1508 and S1509 in FIG. 15.

In step S2111, the CPU 201 determines whether a blank slot exists in the output paper. The CPU 201 may use a determination expression to determine whether a blank slot exists in the output paper. For example, the determination expression is expressed as “A/B=C+D” where the number of copies after cutting is A and the maximum number of sheets having the output paper size to which the paper size after cutting can be allocated is B. In a case where a solution of A/B is an integer solution C and a remainder D, the determination is made depending on whether the remainder D is zero. In a case where the remainder D is zero (NO in step S2111), the CPU 201 determines that no blank slot exists, and the processing proceeds to step S2109. In a case where the remainder D is not zero (YES in step S2111), the CPU 201 determines that a blank slot exists in the output paper, and the processing proceeds to step S2112.

In step S2112, the CPU 201 allocates each scanned page of the document to a sheet of paper to be fed of the output paper size as long as no blank slot exists to perform printing. Thus, the CPU 201 performs a printing process as many sheets as the product of the integer solution C of “A/B” and the number of document pages.

In step S2113, the CPU 201 allocates scanned pages of the document corresponding to the remainder D to sheets of paper to be fed of the output paper size and then printing is performed. Thereafter, the CPU 201 executes processing in step S2110, and the flowchart ends.

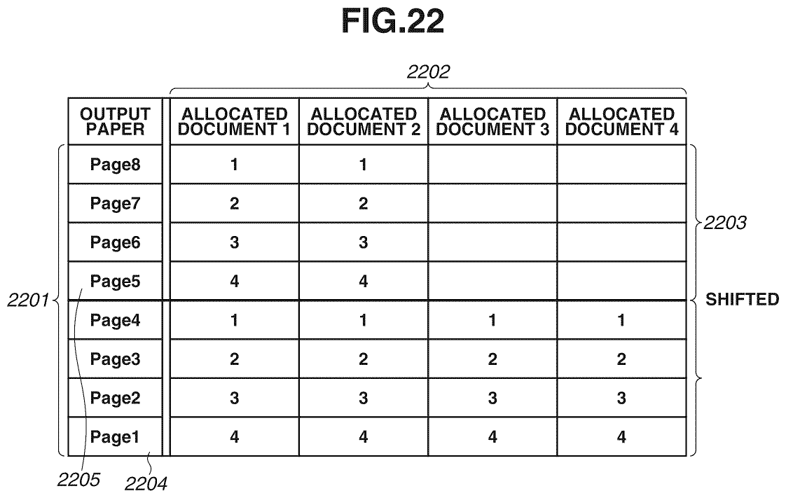

A specific example will be described with reference to FIGS. 22, 23, 24, and 25. The specific example is a case where the output paper size registered in the paper feed cassette, which is set on the paper feed cassette selection screen 1100 illustrated in FIG. 11, is A3, the paper size of the document read by the scanner 102 is A4, the number of sheets is 4, the paper size after cutting set on the copy-and-cut setting screen 700 illustrated in FIG. 7 is A5, and the number of copies 503 illustrated in FIG. 5 is 6.

FIG. 22 is a table showing an example of a document whose pages are allocated to output sheets of paper and the output sheets of paper with the blank slot removal button 2001 illustrated in FIG. 20 not selected, in executing the cutting-oriented copy illustrated in FIG. 21, which allows the number of copies after cutting to be set with any blank slot removed. Each row 2201 shows page numbers of the output sheets of paper and each column 2202 shows pages of the document allocated to the output sheets of paper. For example, a first row 2204 in the output paper indicates that four fourth pages of the document are allocated to the first page of the output sheets of paper. Further, a fifth row 2205 in the output paper indicates that the output paper is output so that two fourth pages of the document are allocated to the fifth page of the output sheets of paper.

Four sheets having the “A5” paper size after cutting can be allocated to an output sheet of paper having the “A3” paper size, and thus, the printer unit 302 allocates four fourth pages of the read document to the first page of the output sheets of paper. Thereafter, the printer unit 302 allocates four third pages of the read document to the second page of the output sheets of paper, and sequentially performs printing up to the first page of the document. In a case where the blank slot removal button 2001 illustrated in FIG. 20 is not selected, the printer unit 302 allocates again two fourth pages of the document to the fifth page of the output sheets of paper to perform printing after the printing on the first page of the document. Thereafter, the printer unit 302 allocates again two third pages of the read document to the sixth page of the output sheets of paper, and sequentially performs printing up to the first page of the document. Thus, two sheets having A5 size are allocated to sixth to eighth pages 2203 of the output sheets of paper having A3 size.

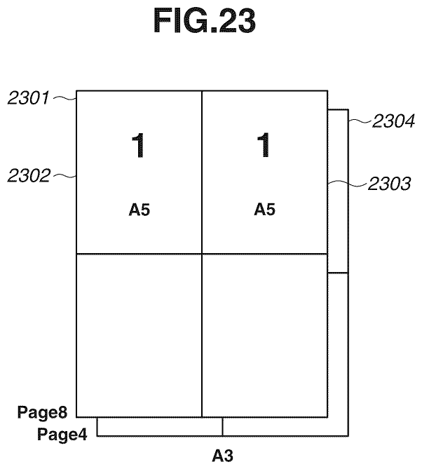

FIG. 23 illustrates an example of the document whose pages are allocated to output sheets of paper and the output sheets of paper with the blank slot removal button 2001 illustrated in FIG. 20 not selected, in executing the cutting-oriented copy illustrated in FIG. 21, which allows the number of copies after cutting to be set with any blank slot removed. The first pages of the document are allocated to slots 2302 and 2303 on an eighth page 2301 of the output sheets of paper. On the other hand, four first pages of the document are allocated to a fourth page 2304 of the output sheets of paper.

When the cutting-oriented copy illustrated in FIG. 20 is executed, which allows the number of copies after cutting to be set, with the blank slot removal button 2001 unselected, each of the shifted output sheets of paper is cut, making it possible to provide a printed product desired by the user without sorting or grouping of the sheets of paper.

For example, in the case of the specific example illustrated in FIGS. 22 and 23, cutting the first to fourth pages of the output sheets of paper having A3 size makes it possible to create four bundles of paper having A5 size in which the first to fourth pages of the document are arranged. Subsequently, cutting the fifth to eighth pages of the shifted output sheets of paper makes it possible to further create two bundles of paper having A5 size in which the first to fourth pages of the document are arranged and two bundles of paper having A5 size in which four blank slots are arranged.

Thus, a total of six bundles of paper having A5 size in which the first to fourth pages of the document are arranged as intended by the user can be created with the simple settings. Meanwhile, the two bundles of paper having A5 size with the four blank slots arranged are waste paper.

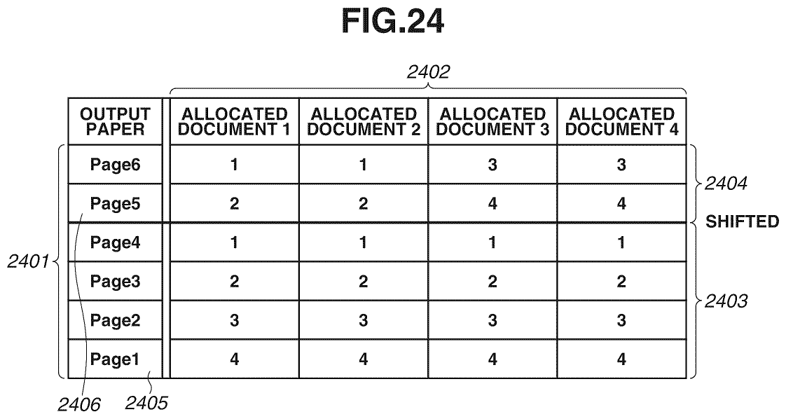

FIG. 24 is a table showing an example of the document whose pages are allocated to output sheets of paper and the output sheets of paper with the blank slot removal button 2001 illustrated in FIG. 20 selected, in executing the cutting-oriented copy illustrated in FIG. 21, which allows the number of copies after cutting to be set with any blank slot removed. Each row 2401 shows page numbers of the output sheets of paper, and each column 2402 shows pages of the document allocated to the output sheets of paper. For example, a first row 2405 in the output paper indicates that the output paper is output so that four fourth pages of the document are allocated to the first page of the output sheets of paper. For example, a fifth row 2406 in the output paper indicates that two second pages of the document and two fourth pages of the document are allocated to the fifth page of the output sheets of paper.

In the specific example, the number of copies after cutting is six, the maximum number of sheets to which the paper size after cutting can be allocated is four, and the integer solution of the determination expression is one and the remainder is two. Thus, in step S2112, four sheets are output, which is obtained by multiplication of an integer solution of one by a document page number of four, as first to fourth pages 2403 of the output paper. Subsequently, the remaining two copies of the document are printed on fifth to sixth pages 2404 of the output sheets of paper. In printing on the fifth to sixth pages 2404 of the output paper, the output sheets of paper are laid out so that, after the final shifted output sheets of paper are cut, the cut sheets are merely placed on each other for the first to fourth pages of the document to be placed on each other in order of page as illustrated in FIG. 24.

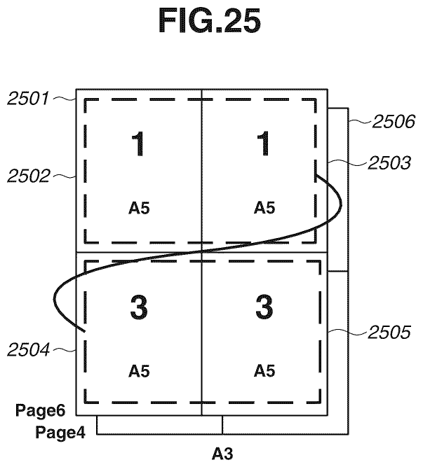

FIG. 25 is a table showing an example of the document whose pages are allocated to output sheets of paper and the output sheets of paper with the blank slot removal button 2001 illustrated in FIG. 20 selected, in executing the cutting-oriented copy in FIG. 21 that allows the number of copies after cutting to be set with any blank slot removed. Printing is performed with the first page of the document allocated to slots 2502 and 2503 and the third page of the document allocated to slots 2504 and 2505 on a sixth page 2501 of the output sheets of paper. Meanwhile, four first pages of the document are allocated to a fourth page 2506 of the output sheets of paper.

When the cutting-oriented copy is executed that allows the number of copies after cutting to be set with the blank slot removal button 2001 selected, each of the shifted output sheets of paper is cut, making it possible to provide a product desired by the user without generating waste paper while minimizing sorting or grouping of paper.

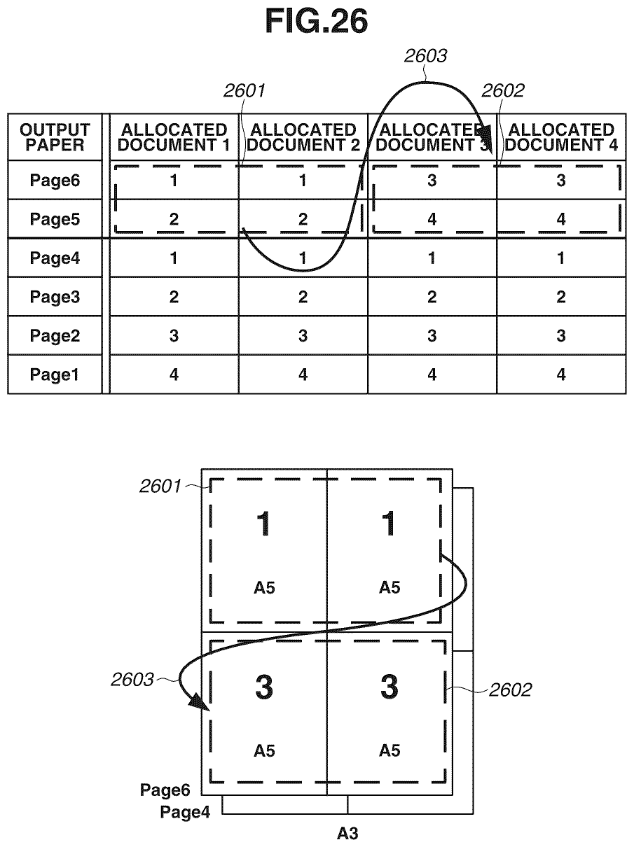

A cutting process in the case of the specific example illustrated in FIGS. 24 and 25 will be described with reference to FIG. 26. Cutting the first to fourth pages of the output sheets of paper having A3 size makes it possible to create four bundles of paper having A5 size in which the first to fourth pages of the document are arranged. Subsequently, cutting the fifth to sixth pages of the shifted output sheets of paper makes it possible to further creates two bundles of paper having A5 size (2601) in which the first to second pages of the document are arranged, and two bundles of paper having A5 size (2602) in which the third to fourth pages of the document are arranged. Thus, merely placing the bundles of paper having A5 size (2601) in which the first to second pages of the document are arranged over the bundles of paper having A5 (2602) in which the third to fourth pages of the document are arranged in a manner as indicated by an arrow 2603 makes it possible to create two bundles of paper having A5 size in which the first to fourth pages of the document are arranged.

As described above, in FIG. 16, the CPU 201 performs allocation so that the documents to be allocated to a set of output sheets of paper before the shift and the documents to be allocated to a set of output sheets of paper after the shift are the same as each other based on the output paper size, the paper size after cutting, and the number of copies after cutting.

In FIGS. 22 and 26, the CPU 201 performs allocation so that the pages of the document to be allocated to a set of output sheets of paper before the shift and the pages of the document to be allocated to a set of output sheets of paper after the shift are different from each other based on the output paper size, the paper size after cutting, and the number of copies after cutting.

In FIG. 22, the maximum number of document pages to be allocated to each of the output sheets of paper before the shift and the maximum number of document pages to be allocated to each of the output sheets of paper after the shift are different from each other.

In FIG. 26, the maximum number of document pages to be allocated to each of the output sheets of paper before the shift and the number of document pages to be allocated to each of the output sheets of paper are the same as each other, and the numbers of pages of the set of output paper before the shift and the number of pages of the set of output paper after the shift are different from each other.

the functions of the cutting-oriented copy illustrated in the flowcharts in FIGS. 12, 15, and 21 can be used in executing a cutting-oriented printing from the personal computer 107. For example, in the case of the cutting-oriented copy in FIG. 15 that allows the number of copies to be set after cutting, a cutting-oriented printing can be executed with the documents read by the scanner 102 in step S1508 or S1504 serving as document data received from the personal computer 107.

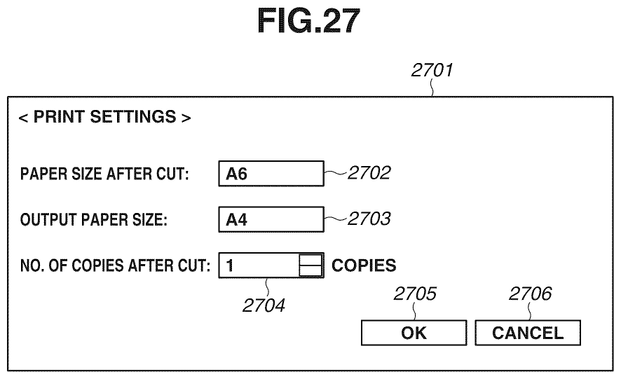

A print setting screen 2701 illustrated in FIG. 27 is used to configure print settings using the personal computer 107.

Settings in the paper-size-after-cut button group 701 illustrated in FIG. 7 are configured on a pull-down menu 2702 for a paper size setting after cutting at the time of printing illustrated in FIG. 27. An output paper size registered in a paper feed cassette set on the paper feed cassette selection screen 1100 illustrated in FIG. 11 is set using a pull-down menu 2703 for an output paper size setting at the time of printing illustrated in FIG. 27. The number of copies 503 on the copy basic screen 501 illustrated in FIG. 5 is set using the number of copies after cutting at the time of printing 2704 illustrated in FIG. 27.

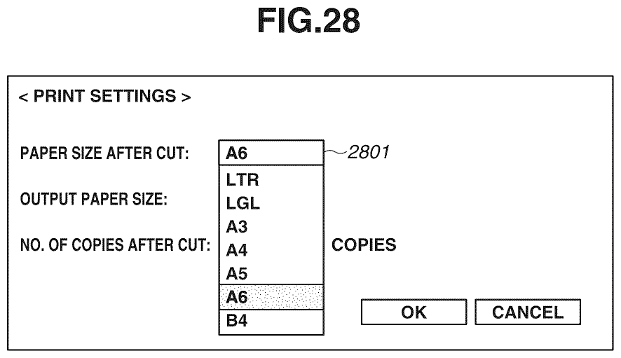

On the print setting screen 2701, the settings can be determined by pressing an OK button 2705 and can be canceled by pressing a cancel button 2706. In the pull-down menu 2702 for a paper size setting after cutting at the time of printing and the pull-down menu 2703 for an output paper size setting at the time of printing, settable selection values as illustrated in FIG. 28 are displayed. For example, in a pull-down menu 2801 for a paper size setting after cutting at the time of printing, each button of the paper-size-after-cut button group 701 illustrated in FIG. 7 is displayed as a selection item. Further, the print setting screen 2701 illustrated in FIG. 27 can be displayed both on the personal computer 107 and on a mobile terminal or the like.

Receiving the user's settings by displaying the print setting screen 2701 facilitates configuration of print settings when the user cuts paper to a desired paper size after printing both at the time of a cutting-oriented copy and at the time of a cutting-oriented printing.

In a cutting-oriented copy, the CPU 201 acquires data about documents using the scanner 102. In a cutting-oriented printing, the CPU 201 receives data about documents from the personal computer 107.

As described above, according to the present embodiment, a desired output product can be obtained with simple settings when the user cuts paper to a desired paper size after printing. Further, when an output product is processed by being cut after printing, time and effort required for sorting and blank slots after cutting can be reduced.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-190906, filed Oct. 30, 2024, which is hereby incorporated by reference herein in its entirety.

What is claimed is:

1. An image forming apparatus comprising:
at least one memory storing instructions; and
at least one processor that, upon execution of the stored instructions, causes the at least one processor to operate as:
a first acquisition unit configured to acquire an output paper size;
a second acquisition unit configured to acquire a paper size after cutting; and
a first control unit configured to perform control to allocate a document having the paper size after cutting to output paper having the output paper size to perform printing.

2. The image forming apparatus according to claim 1, wherein the first control unit is configured to:
in a case where a cutting-oriented copy or a cutting-oriented printing is set, perform control to allocate the document having the paper size after cutting to the output paper having the output paper size to perform printing; and
in a case where the cutting-oriented copy or the cutting-oriented printing is not set, perform control to print the document on the output paper having the output paper size instead of allocating the document having the paper size after cutting to the output paper having the output paper size.

3. The image forming apparatus according to claim 1,
wherein the at least one processor, upon execution of the stored instructions, causes the at least one processor to further operate as a third acquisition unit configured to acquire the number of copies after cutting, and
wherein the first control unit is configured to perform control to allocate a document having the paper size after cutting according to the number of copies after cutting to the output paper having the output paper size to perform printing.

4. The image forming apparatus according to claim 3,
wherein the at least one processor, upon execution of the stored instructions, causes the at least one processor to further operate as a fourth acquisition unit configured to acquire the number of copies,
wherein the first control unit is configured to:
in a case where a cutting-oriented copy or a cutting-oriented printing is set, perform control to allocate the document having the paper size after cutting according to the number of copies after cutting to the output paper having the output paper size to perform printing; and
in a case where the cutting-oriented copy or the cutting-oriented printing is not set, perform control to print the document on the output paper having the output paper size according to the number of copies acquired by the fourth acquisition unit instead of allocating the document having the paper size after cutting according to the number of copies after cutting to the output paper having the output paper size.

5. The image forming apparatus according to claim 4,
wherein the first control unit is configured to:
in a case where the cutting-oriented copy or the cutting-oriented printing is set, perform control to allocate a document including a plurality of pages each having the paper size after cutting according to the number of copies after cutting to output paper including a plurality of pages each having the output paper size to perform printing; and
in a case where the cutting-oriented copy or the cutting-oriented printing is not set, perform control to print the document including the plurality of pages on the output paper including the plurality of pages each having the output paper size according to the number of copies acquired by the fourth acquisition unit instead of allocating the document including the plurality of pages each having the paper size after cutting according to the number of copies after cutting to the output paper including the plurality of pages each having the output paper size, and
wherein the at least one processor, upon execution of the stored instructions, causes the at least one processor to further operate as: a second control unit configured to:
in a case where the cutting-oriented copy or the cutting-oriented printing is set, control a finisher to shift an output position of printed output paper each time all of the plurality of pages included in the document are printed; and
in a case where the cutting-oriented copy or the cutting-oriented printing is not set, control the finisher to shift the output position of the printed output paper for each copy of the copies corresponding to the number of copies acquired by the fourth acquisition unit.

6. The image forming apparatus according to claim 3,
wherein the first control unit is configured to perform control to allocate a document including a plurality of pages each having the paper size after cutting according to the number of copies after cutting to output paper including a plurality of pages each having the output paper size to perform printing, and
wherein the at least one processor that, upon execution of the stored instructions, causes the at least one processor to further operate as a second control unit configured to control a finisher to shift an output position of printed output paper each time all the plurality of pages of the document are printed.

7. The image forming apparatus according to claim 6, wherein the first control unit is configured to perform allocation so that a document to be allocated to a set of output paper before the shift and a document to be allocated to a set of output paper after the shift are the same as each other based on the output paper size, the paper size after cutting, and the number of copies after cutting.

8. The image forming apparatus according to claim 6, wherein the first control unit is configured to perform allocation so that a document to be allocated to a set of output paper before the shift and a document to be allocated to a set of output paper after the shift are different from each other based on the output paper size, the paper size after cutting, and the number of copies after cutting.

9. The image forming apparatus according to claim 8, wherein the number of document pages to be allocated to each piece of the output paper before the shift and the number of document pages to be allocated to each piece of the output paper after the shift are different from each other.

10. The image forming apparatus according to claim 8,
wherein the number of document pages to be allocated to each piece of the output paper before the shift and the number of document pages to be allocated to each piece of the output paper after the shift are the same as each other, and
wherein the number of pages of the set of output paper before the shift and the number of pages of the set of output paper after the shift are different from each other.

11. The image forming apparatus according to claim 1, wherein the at least one processor, upon execution of the stored instructions, causes the at least one processor to further operate as a fifth acquisition unit configured to acquire data about the document using a scanner.

12. The image forming apparatus according to claim 1, wherein the at least one processor, upon execution of the stored instructions, causes the at least one processor to further operate as a receiving unit configured to receive the document.

13. A method for controlling an image forming apparatus, the method comprising:
performing first acquisition to acquire an output paper size;
performing second acquisition to acquire a paper size after cutting; and
performing first control to allocate a document having the paper size after cutting to output paper having the output paper size to perform printing.

14. A non-transitory computer-readable storage medium that stores a program causing a computer to execute a method of controlling an image forming apparatus, the method comprising:
performing first acquisition to acquire an output paper size;
performing second acquisition to acquire a paper size after cutting; and
performing first control to allocate a document having the paper size after cutting to output paper in the output paper size to perform printing.
